(19) United States
(12) Patent Application Publication
(10) Pub. No.: US 2006/0174265 A1
(43) Pub. Date: Aug. 3, 2006

(54) Method and apparatus for detecting radio content

(76) Inventor: David L. Hauser JR., Newport Beach, CA (US)

Correspondence Address: David L. Hauser, Jr., 331 Monte Carlo Drive, Newport Beach, CA, 92660, US

(21) Appl. No.: 11/392,056

(22) Filed: Mar. 29, 2006

Related U.S. Application Data
(63) Continuation of application No. 10/839,108, filed on May 5, 2004.
(60) Provisional application No. 60/467,926, filed on May 5, 2003.

(51) Int. Cl. H04N 7/025; G06F 13/00; H04N 7/10; H04N 5/445

(52) U.S. Cl. 725/34; 725/46; 725/35

(57) ABSTRACT

A central database provides a location for creating and storing samples of known television commercials. The database of commercial samples is downloaded to a set-top box via a communicate link. The set-top box incorporates a processor for comparing a television signal with the database of known commercial messages to detect the presence of commercial messages. The set-top box may be used to control a recording unit to stop recording for the duration of the commercial message or flag the commercial message for muting or manual skipping during playback. Using this system, the user has the ability to positively detect commercial messages and eliminate the commercials from viewing if desired.

### RELATED APPLICATIONS

The present application is a continuation of U.S. application Ser. No. 10/839,108, filed May 5, 2004, which claims priority under 35 U.S.C. §119(e) to provisional application 60/467,926, filed May 5, 2003, the entireties of which are herein incorporated by reference.

### BACKGROUND OF THE INVENTION

1. Field of the Invention

The present invention relates to the field of recording and playback systems, and more particularly, to a method and apparatus for detecting commercial messages or other media content.

2. Description of the Related Art

Video recording systems have gained widespread popularity for the purpose of recording a television broadcast and then viewing the broadcast at a later time. While later viewing the recorded program, it is well known that most viewers prefer to skip the commercials. Using a conventional video-cassette recorder (VCR) or a digital video recorder (DVR), skipping or bypassing commercials typically involves manually fast-forwarding the recorded program during playback until the commercials are over.

In order to facilitate skipping television commercials, a variety of devices and systems have been proposed over the years for providing home viewers with the ability to detect commercial messages such that the commercials can be more easily avoided. These proposals have typically involved analyzing the characteristics of the incoming broadcast signal to differentiate between a commercial message and desired programming content. When the broadcast signal exhibits characteristics consistent with those of a commercial message, the recording device is automatically paused.

One system of this type detects the absence of video modulation (i.e., a blank frame) in a television signal. When a blank frame is detected, a timing circuit is triggered, thereby causing a pause command to be sent to a video recorder. The pause command remains asserted for a predetermined period of time, or longer if the timing circuit is re-triggered. However, systems of this type suffer from a wide variety of shortcomings and therefore have not met with great success. For example, program material immediately following a commercial break is irretrievably lost if the recorder is paused for too long of a period. Furthermore, a system of this type cannot accurately detect commercial messages with a high success rate. Still further, program material is irretrievably lost if the timing circuit is falsely triggered, such as by a fade between scenes in the program.

In order to overcome these drawbacks, alternative systems have been proposed wherein a real time analysis of the television signal is performed immediately following a blank frame. The analysis may measure the activity level of the signal to determine whether the broadcast message is a commercial. This approach helps reduce the number of false triggers, but is still susceptible to misclassification.

Yet a different approach for avoiding television commercials involves the manual placement of electronic markers on a tape to indicate the beginning and ending of a commercial segment. To achieve this, it is necessary for a human operator to view the television signal as the program is recorded or is replayed. The operator places an electronic mark on the tape and when the tape is subsequently replayed, the VCR can be commanded to fast-forward through the portions of tape bounded by the applied marks.

Although these and numerous other schemes have been proposed, none of the existing methods and devices has the capability to positively detect the presence of a commercial message and thereby avoid false triggers. Accordingly, misclassification will inevitably occur and will cause portions of the program material to be irretrievably lost, which can be extremely aggravating to the user. Because misclassification is relatively common with existing schemes, none has achieved widespread popularity. Accordingly, a need exists for a system that is capable of positively detecting the presence of a television commercial. The present invention addresses this need.

### SUMMARY OF THE INVENTION

A need exists for a system that is capable of positively detecting the presence of a television commercial or other media content from an incoming signal. To be practical, it is desirable that such a system operates in real-time to detect and prevent the recording of unwanted material. It is also desirable that such a system provides the capability to shut down or flag the recording of the incoming signal for the duration of the television commercial. It is also desirable that such a system be relatively inexpensive to operate and easy to use. It is also desirable that such a system be compatible with existing technology and infrastructure and are configurable for use with a wide variety of recording devices, including digital video recorders (DVR's).

In one preferred embodiment of the present invention, an apparatus is provided for quickly and accurately detecting program material in a television signal. The apparatus may be used to provide a mechanism for controlling the operation of a video recording and playback device for automatically eliminating commercial messages during playback of a recorded television signal. One embodiment generally comprises a central database, a set-top box, and a communication link between the central database and the set-top box. The central database is used for collecting and storing data on known television commercial messages and the communication link is used for downloading information about a known group of television commercials to the set-top box. The set-top box generally comprises a control unit and a local memory unit (e.g., a hard drive). The local memory unit is used to store the information on a known group of commercials. The control unit includes a comparison device for comparing the television broadcast signal with the database of commercials in the local memory unit for positively detecting when a commercial message or other program material is being broadcast.

In one aspect, each of the known television commercials is sampled to provide a “thumbprint” or “signature” for each commercial. The signature preferably corresponds to the beginning portion of the television commercial. Each of the known commercial signatures is then downloaded from the central database to the set-top box via the communication link for real-time comparison with the television broadcast signal. By using a signature of relatively short duration, the local memory unit is capable of maintaining a large database of commercials using a relatively small amount of memory or other storage space.

In another aspect, the set-top box may further include a recording device. The recording device may be controlled to stop recording the television signal while a commercial is being shown.

In another aspect, the downloaded signature of the television commercial includes information regarding the duration of the commercial. Using this information, the home recording device may be controlled to stop recording for the duration of the commercial message and start recording when the commercial has ended.

In another aspect, the set-top box may be used to flag the commercials in a recorded program. Using this embodiment, the user has the ability to skip the commercial if he or she desires during playback.

In another aspect, the database of known television commercials can be downloaded to the set-top box via a variety of different communication links such as, for example, a telephone line, DSL, cable, fiber-optic connection, satellite, broadcast signal or other means.

In another aspect, the central database of commercial signatures may be created by one or more human operators or may be automated. In the automated embodiments, an algorithm may be used to detect when a commercial has commenced based on criteria such as, for example, activity level, blank frames, audio channels, volume and color schemes.

One preferred method of detecting and eliminating television program material generally comprises: sampling known television commercials, compiling a central database of television commercial samples, downloading the samples to a set-top box, and comparing the television signal with the stored samples to detect the presence of a commercial message. If the television signal matches one of the samples, that portion of the received signal is identified as a commercial. When a commercial is detected, the home recording device may be temporarily paused for the duration of the commercial. Alternatively, the recording device may flag the commercial such that it can be muted or manually skipped during playback.

### BRIEF DESCRIPTION OF THE DRAWINGS

FIG. 1 is a block diagram illustrating one preferred embodiment of a system for detecting television program material.

FIG. 2 is a block diagram illustrating one embodiment of a set-top box having preferred features of the present invention.

### DETAILED DESCRIPTION OF THE PREFERRED EMBODIMENTS

Preferred embodiments of the present invention provide an apparatus and method for detecting program material in a television signal. The ability to detect program material may be used to control the operation of a video recording device for flagging and/or eliminating commercial messages during playback of a recorded television signal.

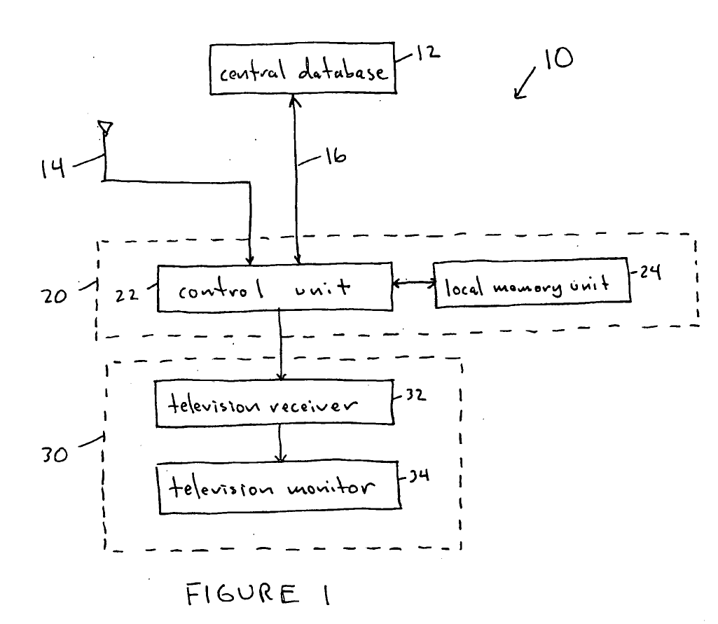

Referring now to FIG. 1, one preferred embodiment of a system 10 having the ability to detect commercial messages generally comprises a central database 12, a set-top box 20, a television 30, and a communication link 16 between the central database and the set-top box. It will be understood that, in alternative configurations, the set-top box 20 or portions thereof may be combined with the television 30 into a single unit. As illustrated the television 30 generally comprises a television receiver 32 and a television monitor 34.

The central database 12 provides a data storage location for collecting and storing data on known television commercial messages or other program material. The central database of commercials may be created by human operation, by automated systems, or by a combination thereof. When created by human operation, a person or persons monitors television programming and notes the presence of a commercial. Automated systems may be used to detect the presence of television commercials based on criteria, such as, but not limited to, blank frames, color schemes, changes in audio or changes in activity levels. Each time a commercial (or other program material) is detected, a portion of the commercial is sampled and stored in the database. Preferably, the first portion of the television commercial is sampled. The sample may include portions of the audio, video or a combination of both. The central database 12 will preferably also compile information on commercials that are no longer being shown on television. It should be understood that the term “central database” is used for ease of description and does not necessarily describe a single physical location. Rather, the central database may comprise a plurality of different locations wherein data is stored and may be downloaded to the set-top box.

The set-top box 20 preferably comprises a control unit 22 and a local memory unit 24, such as a hard drive. Preferably, the set-top box 20 also includes a recording unit for digitally recording a television program. The local memory unit 24 stores the commercial signatures that have been compiled and downloaded from the central database 12. The commercial signatures are downloaded from the central database 12 to the local storage unit 24 via the communication link 16. The communication link 16 may take the form of any link whereby information can be transferred from the central database 12 to the set-top box 20. For example, the database of known television commercials can be downloaded to the set-top box via a telephone line, DSL connection, cable, fiber-optic connection, diskette, compact disc, satellite, broadcast or any other suitable means.

The control unit 22 preferably uses a comparison algorithm for comparing the television signal with the database of known commercials stored in the local memory unit for positively detecting when a commercial message is being broadcast. The comparison is preferably performed in real-time.

As mentioned above, preferred embodiments may further comprise a recording unit for recording the television signal. The recording unit preferably stores the program material in a digital format, but may store the program material in an analog format. When using a recording unit, the control unit 22 controls which portions of the television program are recorded. In addition, the control unit 22 may be used to provide the user with the ability to avoid viewing the television commercials in a wide variety of other fashions. For example, the control unit may be used to mute or reduce the audio, turn off or dim the video, change the channel, change the audio to music or change the video to a pre-selected screen image. Alternatively, the control unit may flag the commercials in the recorded program such that the user has the ability to manually skip the commercials during playback if desired. In addition, the control unit may provide a visual or aural indication of how much time is left in the commercial and/or when regular programming has resumed. In one embodiment, a visual indication may take the form of a bar graph that is displayed on the television monitor.

In one preferred mode of operation, a short duration of the signal at the beginning of the television commercial is sampled and stored in the central database to provide a commercial signature. Preferably, each of the commercial signatures is downloaded from the central database and is stored on the set-top box in the local memory unit. The control unit in the set-top box compares the locally stored commercial signatures with the television broadcast signal. By providing a signature of relatively short duration, the local memory unit in the set-top box is capable of maintaining a large database of commercial signatures using a relatively small amount of memory or other storage space.

Preferably, along with the signature of each television commercial, information is downloaded that indicates the duration of the television commercial. Using this information, the control unit in the set-top box may be used to stop recording the television broadcast for the precise duration of the commercial message. At the end of the television commercial, the control unit will once again compare the broadcast signal with the signature database to determine if another commercial message is being broadcast. If another commercial is then detected, the recorder will remain in a pause mode. This process will continue until no more commercials are detected, at which time the home recording system will once again resume recording.

Alternatively, a sample of the end portion of the television commercial may be downloaded from the central database to the set-top box. In this embodiment, the control unit is able to positively detect when the commercial is ending.

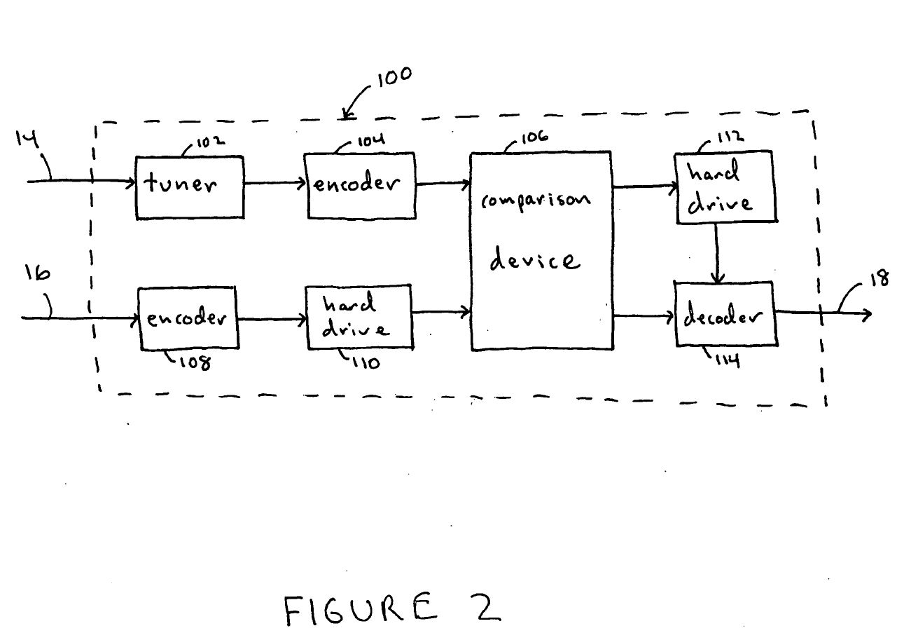

Referring now to FIG. 2, one preferred embodiment of a set-top box 100 is illustrated in more detail. As illustrated, the television signal 14, such as from an antenna, cable or satellite receiver, provides a first input into the set-top box. A data signal 16, such as from a phone line or cable, provides a second input into the set-top box. Although the inputs are shown separately, a single input line, such as from a cable or satellite, may be used for both inputs.

The incoming data signal 16 is received from the central database (element 12 in FIG. 1) and includes information on commercial messages, such as a series of signatures which correspond to the beginning portions of known commercial messages. As discussed above, information regarding the duration of the commercial may also be included along with the signature. The data signal 16 is then directed to an encoder 108 for conversion from analog to digital, if necessary. The signal may be compressed for storage, such as an MPEG-2 file. The compressed signal is then stored on a hard drive 110, which maintains a local database of information relating to known commercials.

The incoming television signal 14 is directed to a tuner 102, which selects the frequency of the desired channel. The output from the tuner 102 is then directed to an encoder 104. If necessary, the encoder converts the signal from analog to digital. If desired, the signal may then be compressed for storage. In one preferred embodiment, the signal is compressed for storage as an MPEG-2 file.

A comparison device 106 compares the incoming compressed digital television signal with the local database of known commercials. If no commercials are detected, the incoming compressed digital television signal may be directed to a hard drive 112 for storage (for later viewing). Alternatively, the television signal may be directed to a decoder 114, which provides an output signal 18 from the set-top box 100, which in turn provides an input signal to the television receiver. If a commercial message is detected while the program is being recorded on the hard drive, the output from the comparison device 106 may be temporarily stopped for the duration of the commercial. If desired, a buffer may be integrated with the comparison device such that the comparison device may adjust the signal to delete the portion of the commercial that was received by the comparison device before the commercial was positively identified. Although FIG. 2 illustrates various components separately for ease of description, it will be appreciated that certain elements, such as encoders and/or hard drives, may be combined.

If a commercial message is detected during live television viewing, the output signal 18 from the set-top box 100 may be altered as desired by the user. For example, the output signal 18 may be altered to mute or reduce the volume. Alternatively, the output signal may be temporarily shut off. In yet another alternative embodiment, the output signal may be switched to a desired image or to a desired audio signal (e.g., music) during the commercial break.

It is recognized that new commercials will be shown from time to time which have not yet been sampled and stored in the central database. Therefore, it may not always be possible to detect each and every commercial that is shown. However, television commercials are typically shown in a group of at least three having a total duration of at least two minutes. As a result, various modifications may be used to facilitate complete and accurate detection of commercials despite the fact that not all commercials may be contained in the database. For example, the comparison logic in the control unit may detect only the first and third commercials in a group with a time gap of 30 seconds in between. If desired, the logic in the control unit may configured to assume that the 30 second gap is also a commercial such that the entire commercial block is detected and treated accordingly.

In an alternative embodiment, a system is provided wherein the user may identify particular media content for a variety of purposes. For example, when a commercial is aired, the user may press a button on a remote control to indicate to the set-top box that a commercial is being shown. The set-top box may then use that information to create a signature such that the commercial will be detected next time it is shown. The system may be used with or without a central database. When used with a central database, the signature or entire commercial message may be uploaded to the central server where it is logged and then analyzed and sent to other users. If a signature is created locally, the beginning portion of the commercial message may be detected automatically using known techniques, such as detection of a blank frame to create the signature.

It is further recognized that, over time, commercial messages will be removed from television broadcasts. Accordingly, a list of deleted commercials may be downloaded from the central database to the set-top box on a regular basis. The set-top box will then delete the appropriate commercial signatures from the local memory unit. Alternatively, or in addition, the set-top box may monitor the frequency at which a commercial is detected in a television broadcast. If a commercial pertaining to particular signature has not been detected over a predetermined period of time, the control unit may be used to delete the signature from the local memory unit.

Referring again to FIG. 1, one preferred method of using a system 10 according to one embodiment of the present invention generally comprises compiling a database 12 of signatures relating to known television commercials and downloading the signatures to a set-top box 20 via a communication link 16. The signatures are then stored in a local memory unit 24 and a comparison device 22 uses an algorithm to compare the incoming television signal 14 with the database to detect the presence of a commercial message. If the incoming television signal 14 matches one of the commercial signatures, the received signal is identified as a commercial. When a commercial is detected, the control unit 22 may treat the signal in a manner as desired by the user, such as, for example, the control unit may change channels, switch to an alternative video and/or audio signal, or alter the audio or video signal. If a DVR or other home recording device is used to record the incoming signal, the device may be temporarily paused during the commercial message. Alternatively, the control unit 22 may flag the commercial such that it can be muted or manually skipped during playback on the recording device. In another aspect, a subscription fee service may be provided in combination with the above-described system to provide the ability to detect and/or remove commercials or other media content at a cost to the user.

In another embodiment of the present invention, an alternative system may be used to trigger a recording unit to begin recording program material. For example, an opening segment of a desired television program may be stored in the local memory unit of the set-top box. The set-top box may be configured to commence recording each time the opening segment is detected in a television signal by comparing the television signal with the stored segment. If multiple tuners are used, the set-top box may be capable of analyzing a variety of different channels to search for the segment. In one embodiment, the opening segment of a desired program may be downloaded from a central database, in a manner similar to that described above. Alternatively, the opening segment may be sampled and stored locally by the set-top box.

In yet another alternative embodiment, a marker or other indication means may be inserted into the television signal at the beginning of a television program by the provider of television or other media content. Information on the marker may be downloaded to the set-top box from a central database or other means. Alternatively, the user can configure the set-top box to look for a certain marker. In either case, the set-top box analyzes the television signal to search for the presence of the marker. Using this embodiment, the set-top box may be configured to automatically record desired program material whenever the marker is detected, using multiple tuners if desired.

In yet another alternative embodiment, a marker may also be inserted at the end of the television program to provide a signal to stop recording. This embodiment may be particularly useful when recording sporting events or other events, such as live programming, wherein the end of the event is not fixed in time. In one embodiment, the marker may be inserted by the programming provider (e.g., network or cable company), such as via the incoming signal input 14. Alternatively, the marker may be sent from a service provider, such as via the data input 16. Accordingly, when sent from a service provider, the marker (or other signal) may be sent separately from the incoming signal input. The marker is preferably downloaded in real-time, such as via the data line shown in FIG. 2, for a variety of purposes, such as to command a recording device to begin or stop recording. This embodiment is particularly well-suited for commanding a DVR to stop recording at the end of a particular program that is not fixed in duration (e.g., sporting event).

In yet another alternative embodiment, information may be downloaded from a service provider for a variety of other purposes. Preferably, information may be provided to the user that correlates to a specific television program. For example, the user may be provided with “on-demand” statistics relating to a particular sporting event during the broadcast. Alternatively, the user may be provided with credits or other information relating to a television program.

Although the apparatus and method disclosed herein are primarily discussed in the context of use with a television recording system, it will be appreciated that the improvements may also be applicable to a wide variety of other recording devices and/or other systems for downloading media content. For example, the features of the apparatus and method disclosed herein may also be used to selectively save desirable media content or filter out undesirable media content from the internet. In particular, various embodiments may be used to detect and filter unwanted bulk e-mail (i.e., “spam”) and/or unwanted advertisements, such as “pop-up” ads.

In yet another alternative embodiment, the apparatus and method may be used to filter out undesirable material from a radio signal or may be used to detect the presence of desired material, such as, for example, a favorite song. When the desired material is detected in a radio signal, a control unit may change stations to play the desired material, provide a visual or aural indication that the desired material is being “aired” or command a recording unit to record the material.

While the foregoing detailed description has described several embodiments of the apparatus of the present invention, it is to be understood that the above description is illustrative only and is not limiting of the disclosed invention. It will be appreciated that the specific features of the invention can differ from those described above while remaining within the scope of the present invention.

What is claimed is:

1. A method of detecting preferred program content in an incoming radio signal, comprising:
providing a radio receiver having a tuner, a control unit and a local memory unit;
compiling a database of preferred program content in the local memory unit;
receiving a digitally encoded radio signal;
decoding at least one channel of the incoming radio signal; and
comparing the decoded radio channel with the database of preferred program content to detect the presence of the preferred program content in the incoming radio signal.

2. The method of claim 1, wherein the control unit provides an alert to the listener after detecting the presence of the preferred program content.

3. The method of claim 1, wherein multiple tuners are provided for decoding multiple channels in the incoming radio signal and wherein the multiple decoded channels are compared with the database of preferred program content.

4. The method of claim 3, wherein the control unit changes the channel on the receiver to play the preferred program content after detecting the presence of the preferred program content in the incoming radio signal.

5. The method of claim 3, wherein the database of preferred program content includes sampled portions of the program content and wherein the control unit compares the decoded signals with the sampled portions to detect the preferred program content.

6. The method of claim 1, further comprising providing a recording unit and wherein the control unit causes the recording unit to start recording the channel after detection of preferred program content.

7. The method of claim 1, further comprising inserting information markers into the radio signals and wherein the control unit compares the information markers with the database of preferred program content.

8. The method of claim 7, wherein the information marker includes data regarding the duration of the preferred radio content.

9. The method of claim 1, further comprising downloading data regarding preferred program content from a central database to the local memory unit.

10. The method of claim 9, wherein the data regarding preferred radio content is transmitted from the central database to the local memory unit via satellite transmission.

11. The method of claim 1, wherein a listener manually flags program content while listening to a radio channel and wherein the flagged program content is added to the database of preferred program content.

12. A method of detecting content in an incoming encoded radio signal, comprising:
providing a radio receiver having a tuner and a local memory unit;
downloading information regarding preferred radio content from a central database to the local memory unit;
receiving a digitally encoded radio signal;
decoding multiple channels of the incoming encoded signal;
comparing radio content in the multiple channels with the local database of information to detect the presence of the preferred radio content; and
alerting the user regarding the presence of the preferred radio content.

13. The method of claim 12, further comprising providing a recording unit for storing the preferred radio content in a digital format and wherein the detection of preferred radio content causes the recording unit to start recording

14. The method of claim 12, further comprising inserting an information marker into each channel of the radio signal for providing data regarding radio content and wherein the step of comparing the decoded radio signal with the local database of preferred radio content is performed to detect the presence of a desired marker

15. The method of claim 14, further comprising inserting an end marker at the end of the radio content.

16. The method of claim 15, further comprising providing a recording unit and wherein the detection of the end marker causes the recording unit to stop recording.

17. The method of claim 12, wherein the information regarding preferred radio content is received via satellite from the central database.

18. A method of recording preferred content in a radio broadcast signal, comprising:
providing a set-top box having a tuner, a local memory unit and a recording unit;
entering information regarding preferred radio content into the local memory unit;
receiving a radio broadcast signal;
decoding multiple channels of the incoming encoded signal in substantially real-time;
comparing radio content in the multiple channels with the information in the local memory unit to detect the presence of the preferred radio content; and
causing the recording unit to begin recording after detecting preferred radio content.

19. The method of claim 18, wherein the step of entering information regarding preferred radio content into the local memory unit comprises downloading samples of favorite songs to the local memory unit from a central database.

20. The method of claim 18, wherein the radio channels include information markers regarding radio content and wherein the step of entering information regarding preferred radio content into the local memory unit comprises downloading data about the information markers to the local memory unit from a central database.
